(19) United States
(12) Patent Application Publication
(10) Pub. No.: US 2006/0172136 A1
(43) Pub. Date: Aug. 3, 2006

(54) Coated member

(76) Inventors: Takashi Komori, Kariya-shi (JP); Hisashi Muramatsu, Kariya-shi (JP); Osamu Hidaka, Kariya-shi (JP); Kenichi Yasunaga, Toyota-shi (JP); Takayuki Nagai, Toyota-shi (JP); Masaaki Yamaya, Gunma-ken (JP); Koichi Higuchi, Gunma-ken (JP)

Correspondence Address: MORGAN & FINNEGAN, L.L.P., 3 World Financial Center, New York, NY, 10281-2101, US

(21) Appl. No.: 11/345,101

(22) Filed: Jan. 31, 2006

(30) Foreign Application Priority Data
Feb. 1, 2005 (JP) 2005-025390

(51) Int. Cl. B32B 27/36

(52) U.S. Cl. 428/412

(57) ABSTRACT

A coated member includes a resinous substrate, a primer layer, and a hard coat layer. The primer layer is formed on a surface of the resinous substrate, and is composed of a resinous primer. The hard coat layer is formed on the primer layer, and contains a flexibility-imparting agent. At least one of the primer layer and the hard coat layer further contains an ultraviolet ray-absorbing agent. The coated member exhibits good weatherability, adhesiveness and crack resistance.

### BACKGROUND OF THE INVENTION

1. Field of the Invention

The present invention relates to a resinous member, which is used for various interior materials and organic glass. In particular, it relates to a coated resinous member which is good in terms of the weatherability.

2. Description of the Related Art

Resinous materials have been utilized extensively in applications in many fields, making use of the characteristics such as impact resistance and lightweightness. Among them, transparent resinous materials, which are represented by polycarbonate, have been used as shock-resistant glass not only in windowpanes but also in special applications such as tanks, making use of the following characteristics that they exhibit a light specific weight; are likely to be processed; and are stronger against shocks than inorganic glass. Moreover, transparent resinous materials have been used in optical fields such as lenses and optical fibers. On the other hand, resinous materials have surfaces which are likely to be bruised so that they are likely to lose the glossiness or transparency, and are likely to be adversely affected by organic solvents. In addition, transparent resinous materials have such disadvantages as being poor in terms of the weatherability (that is, optical stability against ultraviolet ray or infrared ray, for example) and heat resistance. Accordingly, resinous materials have been covered with various coats, which are for improving the superficial characteristics of resinous materials, to use. In particular, automotive windshields or interior materials are often exposed to the sun light for a long period of time. Consequently, when making the substrates of automotive windshields or interior materials from resinous materials, it has been needed to form a coat on the substrates in order to inhibit them from degrading optically.

For example, Japanese Unexamined Patent Publication (KOKAI) No. 2001-214,122 discloses a primer layer whose ultraviolet ray-absorbing group is fixed to a polymer main chain by means of chemical bond, and which exhibits an ultraviolet ray-absorbing ability. It is possible to give an ultraviolet ray-absorbing ability to the primer layer disclosed in Japanese Unexamined Patent Publication (KOKAI) No. 2001-214,122 without lowering the adhesiveness to substrate, because the ultraviolet ray-absorbing group is fixed to the polymer main chain by means of chemical bond. Moreover, Japanese Unexamined Patent Publication (KOKAI) No. 2001-348,528 discloses a hard coat layer which comprises a composition containing a reactant of an organic silicon compound with a metallic alkoxide containing a β-diketone group. Since the composition disclosed in Japanese Unexamined Patent Publication (KOKAI) No. 2001-348,528 loses almost all of the uncrosslinked portions even under mild curing condition, it is possible to minimize the occurrence of cracks, which result from the crosslinking of the uncrosslinked portions with time.

In order to further improve the ultraviolet ray-absorbing ability of the primer layer disclosed in Japanese Unexamined Patent Publication (KOKAI) No. 2001-214,122, it is necessary to increase the retention amount of the component, which exhibits an ultraviolet ray-absorbing ability, by thickening the primer layer. However, enlarging the thickness of coat is likely to result in the problem that cracks occur in the coat. Moreover, even if a hard coat layer comprising such a composition as disclosed in Japanese Unexamined Patent Publication (KOKAI) No. 2001-348,528 is used, when a primer layer is disposed between a substrate and the hard coat layer, cracks are likely to occur in the resulting coat. This results from the fact that the expansion and contraction of the primer layer, which are caused by temperature change, increase and decrease the stress in the hard coat layer because the linear expansion coefficient of the primer layer is larger that of the hard coat layer.

### SUMMARY OF THE INVENTION

The present invention has been developed in view of the aforementioned problems. It is therefore an object of the present invention to provide a coated member, which comprises a coat exhibiting good adhesiveness and crack resistance.

A coated member according to the present invention comprises:

a resinous substrate;

a primer layer formed on a surface of the resinous substrate, and composed of a resinous primer; and

a hard coat layer formed on the primer layer, and containing a flexibility-imparting agent;

at least one of the primer layer and the hard coat layer further containing an ultraviolet ray-absorbing agent.

Here, the term, “ultraviolet ray-absorbing agent,” specifies those which exhibit an ability of absorbing light ray whose wavelength is 400 nm or less mainly, preferably from 200 to 400 nm. In addition to general organic ultraviolet ray-absorbing agents and inorganic ultraviolet ray-absorbing agents, the ultraviolet ray-absorbing agent can be a fixed ultraviolet ray-absorbing agent, which is fixed to a resinous primer by means of chemical bond.

In the present coated member, the hard coat layer can preferably contain the flexibility-imparting agent in an amount of from 3 to 60% by weight when the hard coat layer is taken as 100% by weight. Moreover, the primer layer can preferably contain an ultraviolet ray-absorbing agent, and can preferably have a thickness of 8 μm or more.

In the present coated member, the hard coat layer exhibits an enlarged elongation after critical fracture because the hard coat layer contains a flexibility-imparting agent. As a result, the present coated member makes a coated member comprising a coat which is good in terms of the crack resistance (or weatherability crack resistance) and adhesiveness (or weatherability adhesiveness). In the present coated member, the hard coat layer can preferably contain the flexibility-imparting agent in an amount of from 3 to 60% by weight when the hard coat layer is taken as 100% by weight. If such is the case, it is possible to further upgrade the crack resistance and adhesiveness of the resulting coat.

Moreover, since the present coated member comprises the primer layer and the hard coat layer, at least one of which further contains an ultraviolet ray-absorbing agent, it is possible to reduce the dose of ultraviolet ray, which reaches the resinous substrate. Accordingly, it is possible to inhibit the resinous substrate from being degraded by ultraviolet layer. Consequently, the weatherability adhesiveness is upgraded at the interface between the resinous substrate and coat. When the present coated member comprises the primer layer which is thickened to a thick film having a thickness of 8 μm, the upper limit of the addable amount of the ultraviolet ray-absorbing agent increases. Accordingly, it is possible to furthermore inhibit the resinous substrate from being degraded by light. Consequently, the present coated member exhibits furthermore enhanced weatherability adhesiveness.

### BRIEF DESCRIPTION OF THE DRAWINGS

A more complete appreciation of the present invention and many of its advantages will be readily obtained as the same becomes better understood by reference to the following detailed description when considered in connection with the accompanying drawings and detailed specification, all of which forms a part of the disclosure.

FIG. 1 is a perspective diagram for schematically illustrating a coated member according to the present invention, which is used in an automotive sunroof.

FIG. 2 is a cross-sectional diagram taken along the dotted line “2”-“2” of FIG. 1, and is an explanatory diagram for illustrating the present coated member.

FIG. 3 is a graph for illustrating how long it took until cracking or peeling-off was noticed visually in Samples “A” through “D,” coated members of examples according to the present invention and comparative examples, in a xenon lamp-type facilitated weatherability test.

FIG. 4 is a cross-sectional diagram for illustrating a conventional coated member, and is a schematic diagram for explaining a mechanism how cracking occurs in the coat.

FIG. 5 a cross-sectional diagram for illustrating a conventional coated member, and is a schematic diagram for explaining a mechanism how peeling-off occurs in the coat.

### DETAILED DESCRIPTION OF THE PREFERRED EMBODIMENTS

Having generally described the present invention, a further understanding can be obtained by reference to the specific preferred embodiments which are provided herein for the purpose of illustration only and not intended to limit the scope of the appended claims.

Hereinafter, preferable modes for carrying out the present coated member will be described with reference to the drawings.

In a conventional coated member, which comprises a resinous member, a primer layer and a hard coat layer, the coat is cracked or peeled off not only by the affect of the hardness of the respective parts and interfaces between them but also by temporal change resulting from light. FIG. 4 shows such an example: for instance, a primer layer 2, which is formed on the surface of a resinous substrate 1, and a hard coat layer 3 exhibit linear expansion coefficients α, which usually differ greatly, respectively. Specifically, an acrylic primer layer exhibits a linear expansion coefficient α of 3×10⁻⁴ approximately. A silicon hard coat layer exhibits a linear expansion coefficient α of 8×10⁻⁵ approximately. Accordingly, temporal temperature change causes expansion and contraction in the primer layer 2 in the directions designated with the double-headed arrows 6 of FIG. 4 (I), for example. Consequently, the expanding and contracting primer layer 2 applies repetitive stress to the hard coat layer 3. Thus, cracking 7 occurs in the coat, that is, in the primer layer 2 and hard coat layer 3, as shown in FIG. 4 (II). Moreover, heat or light develops crosslinking with time to lower the elongation of the hard coat layer 3 so that the cracking 7 becomes likely to occur. In addition, as shown in FIG. 5, even when the primer layer 2 includes an ultraviolet ray-absorbing agent 20 and the hard coat layer 3 includes an ultraviolet ray-absorbing agent 30, such ordinary ultraviolet ray-absorbing agents 20 and 30 disappear with time because of light or water. Accordingly, ultraviolet ray has eventually degraded the surface 8 of the resinous substrate 1 as shown in FIG. 5 (I). Then, water intrudes into the degraded surface 8, or the interface between the resinous substrate 1 and the primer layer 2, as shown in FIG. 5 (II). Consequently, peeling-off 9 occurs as shown in FIG. 5 (III).

Hence, the present coated member has the following novel construction whose cross-sectional schematic diagram is shown in FIG. 2 as one of the examples. For instance, the present coated member comprises a resinous substrate, a primer layer, and a hard coat layer. The primer layer is formed on a surface of the resinous substrate, and is composed of a resinous primer. The hard coat layer is formed on the primer layer, and contains a flexibility-imparting agent. The primer layer further contains an ultraviolet ray-absorbing agent. The hard coat layer further contains an ultraviolet ray-absorbing agent.

The present coated member comprises the hard coat layer which contains the flexibility-imparting agent. The flexibility-imparting agent gives the hard coat layer flexibility. Accordingly, the cracking or peeling-off of the coat, which results from the hardness difference between the hard coat layer and the primer layer or between the hard coat layer and the resinous substrate, is less likely to occur. Consequently, the present coated member makes a coated member which is good in terms of the crack resistance and adhesiveness. Moreover, the flexibility-imparting agent enlarges the critical elongation of the hard coat layer after fracture. Consequently, even when the primer layer has undergone expansion and contraction repetitively because of temperature change, or even when temporal crosslinking has hardened the hard coat layer, the coat is less likely to crack, and is good in terms of the weatherability.

As the flexibility-imparting agent, it is advisable to use various flexibility-imparting agents which have been used usually. For example, it is possible to use such a flexibility-imparting agent whose average particle diameter is so small that it does not adversely affect the transparency of the hard coat layer. The average particle diameter of the flexibility-imparting agent can preferably be φ1,000 nm or less, further preferably be φ500 nm or less. In particular, the average particle diameter of the flexibility-imparting agent can preferably fall in a range of from φ0.1 to 1,000 nm, further preferably from φ0.1 to 500 nm. When the average particle diameter of the flexibility-imparting agent falls in the preferable range, the flexibility-imparting agent can give the hard coat layer flexibility without impairing the abrasion resistance of the hard coat layer, and can effectively enlarge the critical elongation of the hard coat layer after fracture. Specifically, as for the flexibility-imparting agent, it is possible to name the following:

polysiloxane resins, which are produced by condensing at least one member selected from the group consisting of hydrolyzable silicon compounds by means of hydrolysis, hydrolyzable silicon compounds which are expressed by a chemical formula, R1ₐSiX1₍₄₋ₐ₎, wherein R1 is an organic group whose number of carbon atoms falls in a range of from 1 to 18; X1 is a hydrolyzable group; and “a” is an integer falling in a range of from 0 to 2 (Note that, however, hydrolyzable silicon compounds whose “a” is zero (“a”=0) alone and hydrolyzable silicon compounds whose “a” is two (“a”=2) alone are excluded);

various resins, such as acrylic resins, polyester resins and polyurethane resins; solutions or fine particles of silicone rubber, which is produced by partially or completely crosslinking diorganosilicone whose end group comprises a hydrolyzable silyl group or a polymerizable-group-containing organic group; and

solutions or fine particles of various rubbers, such as polyurethane rubbers and acrylonitrile rubbers. Among them, silicone resins are especially preferable options.

The hard coat layer can preferably contain the flexibility-imparting agent in an amount of from 3 to 60% by weight, further preferably from 5 to 60% by weight, furthermore preferably from 10 to 60% by weight, when the hard coat layer is taken as 100% by weight. When the proportion of the flexibility-imparting agent falls in the preferable range, it is possible to make the coat less likely to crack or peel off while preserving the abrasion resistance. As a result, the present coated member makes a coated member which is good in terms of the abrasion resistance, in addition to the good adhesiveness and crack resistance.

The hard coat layer is not limited in particular as far as it is formed of paint compositions for hard coating, which have been used usually. However, the hard coat layer can preferably be a film, which comprises silicon oxide. Note that silicon oxide can be formed by curing paint compositions, which comprise silicon-containing polymers. Silicon-containing polymers can be represented by polysiloxane (—Si—O—)ₙ and polysilazane (—Si—N—), for instance. Specifically, as for the material of the hard coat layer, it is possible to name the following:

polysiloxanes, which are produced by condensing at least one member selected from the group consisting of hydrolyzable silicon compounds by means of hydrolysis, hydrolyzable silicon compounds which are expressed by a chemical formula, R1ₐSiX1₍₄₋ₐ₎, wherein R1 is an organic group whose number of carbon atoms falls in a range of from 1 to 18; X1 is a hydrolyzable group; and “a” is an integer falling in a range of from 0 to 2 (Note that, however, hydrolyzable silicon compounds whose “a” is zero (“a”=0) alone and hydrolyzable silicon compounds whose “a” is two (“a”=2) alone are excluded), wherein 1 mol of the hydrolyzable group X1 is condensed by means of hydrolysis with 1 mol or more of water;

mixtures of the polysiloxanes, and silica sol or metallic oxide fine particles, such as titanium oxide fine particles;

polysilazanes, which are produced by reacting at least one member selected from the group consisting of hydrolyzable halogenosilicon compounds, which are expressed by a chemical formula, R1ₐSiX2₍₄₋ₐ₎, wherein R1 and “a” specify the same organic group and integer as those in the above-described expression for the polymerizable silicon compounds, with ammonia; and

mixtures of the polysilazanes, and silica sol or metallic oxide fine particles, such as titanium oxide fine particles.

Among the above-described materials, it is preferable to use a coating-agent composition as disclosed in Japanese Unexamined Patent Publication (KOKAI) No. 2001-348,528. For example, the coating-agent composition comprises an organic silicon compound having a hydrolyzable-group-containing silyl group, and a reactant and/or hydrolyzed condensate of a mixture, which contains titanium tetraalkoxide and the other metallic alkoxide, with β diketone. When the hard coat layer is made from such a coating-agent composition, the present coated member is much better in terms of the abrasion resistance and weatherability.

Moreover, as shown in FIG. 2, the hard coat layer 3 can contain the ultraviolet ray-absorbing agent 30 as well as the flexibility-imparting agent 31. The hard coating layer further containing the ultraviolet ray-absorbing agent can inhibit the resinous substrate from degrading optically. Accordingly, the weatherability adhesiveness is upgraded between the resinous substrate and the primer layer. As for the ultraviolet ray-absorbing agent, it is possible to use various fine-particle-shaped ultraviolet ray-absorbing agents. In particular, inorganic ultraviolet ray-absorbing agents are preferable options. The inorganic ultraviolet ray-absorbing agents can be inorganic oxide particles which comprise titanium oxide (TiO₂), cerium oxide (CeO₂), zinc oxide (ZnO), zirconium oxide (ZrO₂), and tin oxide (SnO₂), and indium oxide (In₂O₃ or ITO (or indium tin oxide)).

In addition, as disclosed in Japanese Unexamined Patent Publication (KOKAI) No. 2001-348,528, the hard coat layer can contain a metallic compound, which comprises a reactant and/or hydrolyzed condensate of a mixture, which contains titanium tetraalkoxide and the other metallic alkoxide, with β diketone. In this instance, the ultraviolet ray-absorbing agent can preferably be those whose sublimability is low and which are less likely to be affected by light or water so that they disappear less with time. If such is the case, the resulting hard coat layer inhibits ultraviolet ray from degrading the surface of the resinous substrate. Accordingly, it is possible to retain the adhesiveness between the resinous substrate and the coat (especially, the primer layer) for a long period of time. Consequently, the present coated member makes a coated member which exhibits good weatherability adhesiveness.

The hard coat layer can preferably contain the ultraviolet ray-absorbing agent in an amount of from 0.1 to 20% by weight, further preferably from 0.3 to 20% by weight, furthermore preferably from 0.5 to 10% by weight, when the hard coat layer is taken as 100% by weight. When the proportion of the ultraviolet ray-absorbing agent falls in the preferable range, the ultraviolet ray-absorbing agent can effectively demonstrate the characteristic, inhibiting the resinous substrate from degrading optically, without impairing the abrasion resistance of the hard coat layer. Note that, when the ultraviolet ray-absorbing agent is formed as fine particulate shapes, the average particle diameter of the ultraviolet ray-absorbing agent can preferably fall in a range of from φ0.1 to 500 nm, further preferably from φ1 to 100 nm, furthermore preferably from φ1 to 50 nm.

Moreover, when the hard coat layer is formed of an organopolysiloxane compound to which silica fine particles or colloidal silica is added, it is possible to produce the present coated member which exhibits much higher abrasion resistance.

The thickness of the hard coat layer depends on the types of desirable hard coat layer and on the types of added ultraviolet ray-absorbing agent. However, the hard coat layer can preferably have a thickness of from 3 to 5 μm, further preferably from 3 to 4.8 μm, furthermore preferably from 3 to 4.5 μm. When the thickness of the hard coat layer falls in the preferable range, the cracking or peeling-off of coat is inhibited from occurring effectively. Additionally, the hard coat layer makes a hard coat layer which is good in terms of the abrasion resistance as well.

Moreover, the present coated member comprises the primer layer composed of a resinous primer. The primer layer improves the adhesion between the resinous substrate and the hard coat layer. Since the primer layer is composed of a resinous primer, it is easy to give further characteristics, such as hardness, wear resistance and light resistance, to the primer layer by mixing resinous primers having different properties with each other, or admixing fine particles made of metals or oxides to a resinous primer. The resinous primer for forming the primer layer is not limited in particular as far as it is generally available resinous primers. However, it is possible to name the following resinous primers as preferable resinous primers: epoxy-resin primers, urethane-resin primers, polyester-resin primers, melamine-resin primers, phenol-resin primers, polyamide-resin primers, ketone-resin primers, vinyl-resin primers, and acrylic-resin primers. The acrylic-resin primers can be thermosetting acrylic-resin primers, moisture-curable acrylic-resin primers, thermoplastic acrylic-resin primers, and acrylic-resin primers modified with silane or siloxane. One of the preferable resinous primers can be used independently, or two or more of them can be mixed to use. Among the preferable resinous primers, an acrylic primer, which comprises one of the various acrylic-resin primers, is an especially preferable option.

Specifically, as a preferable raw material for the primer layer, it is possible to name thermosetting and/or moisture-curable (metha)acrylic resin, and thermoplastic (metha)acrylic resin. Note that thermosetting and/or moisture-curable (metha)acrylic resin is copolymer and comprises (metha)acrylic acid derivatives, which contain a reactive group, as a monomer component; and thermoplastic (metha)acrylic resin comprises one of nonreactive (metha)acrylic esters.

As for the (metha)acrylic acid derivative containing a reactive group, it is possible name (metha)acrylic acid derivatives containing an alkoxysilyl group, mono(metha)acrylic esters, (metha)acrylic acids, (metha)acrylic esters containing an amino group, and (metha)acrylic esters containing an epoxy group. The (metha)acrylic acid derivatives containing an alkoxysilyl group can be 3-(metha)acryloxypropyltrimethoxy silane, 3-(metha) acryloxypropyltriethoxy silane, 3-(metha) acryloxypropylmethyldimethoxy silane, 1-[3-(metha) acryloxypropyl]pentamethoxy disilane, 1-[3-(metha) acryloxypropyl]-1-methyl-tetramethoxy disilane, a co-hydrolysis condensate of 3-(metha)acryloxypropyl silane with tetramethoxy silane, and a co-hydrolysis condensate of 3-(metha)acryloxypropyl silane with methyltrimethoxy silane, for example. The mono(metha) acrylicesterscanbe, for example, 2-hydroxyethyl(metha)acrylate, 3-hydroxypropyl(metha)acrylate, 4-hydroxybutyl(metha)acrylate, and mono(metha)acrylic esters of polyhydric alcohol, such as glycerin mono(metha)acrylate, pentaerythritol mono(metha) acrylate, polyethylene glycol mono(metha)acrylate whose number of ethylene glycol units falls in a range of from 2 to 20, for instance, and polypropylene glycol mono(metha)acrylate whose number of propylene glycol units falls in a range of from 2 to 20, for instance. The (metha)acrylic acids can be (metha)acrylic acid, for example. The (metha)acrylic esters containing an amino group can be 2-aminoethyl (metha)acrylate, and 2-(N-methylamino)ethyl(metha) acrylate, for example. The (metha)acrylic esters containing an epoxy group can be glycidyl(metha)acrylate, for example.

As for the nonreactive (metha)acrylic esters, it is possible to name (metha)acrylic esters of monohydric alcohol, (metha) acrylic acid monomers having an annular hindered amine structure, and (metha)acrylic acid derivatives containing an ultraviolet ray-absorbing group. The (metha)acrylic esters of monohydric alcohol can be methyl(metha)acrylate, ethyl(metha)acrylate, n-propyl(metha)acrylate, isopropyl(metha)acrylate, n-butyl (metha)acrylate, isobutyl(metha)acrylate, t-butyl(metha) acrylate, n-hexyl(metha)acrylate, 2-ethylhexyl(metha)acrylate, n-octyl(metha)acrylate, n-decyl(metha)acrylate, lauryl(metha) acrylate, stearyl(metha)acrylate, cyclohexyl(metha)acrylate, 4-methylcyclohexyl(metha)acrylate, 4-t-butylcyclohexyl(metha) acrylate, isobornyl(metha)acrylate, dicyclopentanyl(metha) acrylate, dicyclopentenyl oxyethyl(metha)acrylate, and benzyl (metha)acrylate, for example. The (metha)acrylic acid derivatives containing an ultraviolet ray-absorbing group can be 2-(2′-hydroxy-5′-(metha)acryloxyphenyl)-2H-benzotriazole, 2-[2′-hydroxy-5′-(2-(metha)acryloxyethyl)phenyl]-2H-benzotriazole, 2-[2′-hydroxy-3′-methyl-5′-(8-(metha) acryloxyoctyl)phenyl]-2H-benzotriazole, 2-hydroxy-4-(2-(metha) acryloxyethoxy)benzophenone, 2-hydroxy-4-(4-(metha) acryloxybutoxy)benzophenone, 2,2′-dihydroxy-4-(2-(metha) acryloxyethoxy)benzophenone, 2,4-dihydroxy-4′-(2-(metha) acryloxyethoxy)benzophenone, 2,2′,4-trihydroxy-4′-(2-(metha) acryloxyethoxy)benzophenone, 2-hydroxy-4-(3-(metha)acryloxy-2-hydroxypropoxy)benzophenone, and 2-hydroxy-4-(3-(metha) acryloxy-1-hydropropoxy)benzophenone, for example.

In addition, the acrylic primer can preferably comprise a thermosetting acrylic resin and a thermoplastic acrylic resin, and a weight ratio of the thermosetting acrylic resin with respect to the thermoplastic acrylic resin can preferably fall in a range of from 95:5 to 30:70, further preferably from 90:10 to 35:65, furthermore preferably from 80:20 to 40:60. When the acrylic primer comprise a thermosetting acrylic resin and a thermoplastic acrylic resin in a proportion falling in the preferable range, it is possible to reduce the linear expansion coefficient of the resulting primer layer without adversely affecting the above-described advantages of the primer layer as primer. As a result, the stress, which arises from the expansion and contraction of the primer layer resulting from temperature change with time, is reduced in the primer layer 2. Therefore, it is possible to minimize the occurrence of cracks in the coat of the present coated member.

Moreover, the acrylic primer can preferably comprise a thermoplastic acrylic resin whose weight-average molecular weight falls in a range of from 5,000 to 800,000, further preferably from 10,000 to 700,000, furthermore preferably from 15,000 to 600,000. The glass transition temperature of thermoplastic resin can be expressed by an equation, Tg=Tg^{∞}−K′/M, wherein Tg^{∞} specifies the glass transition temperature of polymer whose molecular weight is infinite; K′ is a constant; and M specifies molecular weight. The larger the average molecular weight M is the higher the glass transition temperature Tg of thermoplastic acrylic resin tends to be. Therefore, when the weight-average molecular weight of the thermoplastic acrylic resin is controlled to fall in the preferable range, the movement of the primer layer (or the thermal motion of polymer) is less likely to occur at high temperatures. As a result, the resulting coat is less likely to crack because the stress, which arises from the flow at high temperatures, diminishes.

In addition, as shown in FIG. 2, the primer layer 2 can preferably further contain the ultraviolet ray-absorbing agent 20. The primer layer containing the ultraviolet ray-absorbing agent can inhibit the resinous substrate from degrading optically. As a result, the weatherability adhesion between the resinous substrate and the primer layer upgrades. As for the ultraviolet ray-absorbing agent, it is possible to use various inorganic or organic ultraviolet ray-absorbing agents which have been used usually. However, a fixed ultraviolet ray-absorbing agent, which is fixed to a resinous primer by means of chemical bond, is an especially preferable option. Since the fixed ultraviolet ray-absorbing agent exhibits low sublimeability, it is possible to inhibit light or water from affecting the fixed ultraviolet ray-absorbing agent to disappear with time. As a result, the surface of the resinous substrate is less likely to be degraded by ultraviolet ray so that the adhesion between the resinous substrate and the primer layer can be retained. When an organic copolymer containing an alkoxy group, for example, as disclosed in Japanese Unexamined Patent Publication (KOKAI) No. 2001-214,122, is used as an undercoating composition for the primer layer, the present coated member makes a coated member, which demonstrates enhanced adhesiveness and is good in terms of the weatherability. Note that the organic copolymer containing an alkoxy group is a copolymer of an ultraviolet ray-absorbing vinyl monomer, a vinyl monomer containing an alkoxysilyl group, and the other copolymerizable monomer.

The primer layer can preferably contain the ultraviolet ray-absorbing agent, which is fixed in the primer layer, in an amount of from 3 to 25% by weight, further preferably from 5 to 20% by weight, furthermore preferably from 8 to 20% by weight, with respect to the primer layer taken as 100% by weight. When the amount of the ultraviolet ray-absorbing agent is less than the lower limit of the preferable range, the resulting primer layer exhibits lowered weatherability adhesiveness because it shows ultraviolet ray-absorbing performance insufficiently so that the resultant coated member is likely to peel off. When the amount of the ultraviolet ray-absorbing agent is more than the upper limit of the preferable range, the adhesion between the resulting primer layer and the hard coat layer lowers so that they are less likely to adhere to each other even at an early stage.

The thickness of the primer layer depends on the types of resinous primer used as the primer and the types of ultraviolet ray-absorbing agent. When the primer layer contains an ultraviolet-ray absorbing agent, the thickness can preferably be controlled to 8 μm or more. When the primer layer has a thickness of 8 μm or more, it is possible to more effectively inhibit the resinous substrate from degrading optically because the upper limit of the amount of the ultraviolet ray-absorbing agent, which can be added to the primer layer, increases. As a result, the weatherability adhesion between the resinous layer and the primer layer upgrades furthermore. Moreover, the thickness of the primer layer can preferably fall in a range of from 8 to 16 μm, further preferably from 8.5 to 15.5 μm. When the thickness of the primer layer falls in the preferable range, it is possible to give the present coated member more favorable weatherability while bonding the resinous substrate and the hard coat layer fully. Note that it has been known generally that the thicker the thickness of film is the more cracking or peeling-off is likely to occur. However, in the present coated member, the hard coat layer, which contains the flexibility-imparting agent, diminishes the occurrence of cracking or peeling-off even when the thickness of the primer layer is 8 μm or more.

The primer layer and the hard coat layer can be desirably formed on the surface of the resinous substrate and on the surface of the primer layer, respectively, by curing a paint composition which is prepared from desirable components after coating it (if necessary, after controlling its viscosity with a solvent). As for the application method, it is possible to employ coating methods, spray coating methods, flow coating methods, spin coating methods, and dip coating methods. Moreover, the paint composition can be cured by selecting temperature or time, which is suitable for its composition, adequately.

The resinous substrate is not limited in particular as far as it is composed of resinous materials, which exhibit characteristics, such as shock resistance and transparency, depending on the applications of the present coated member. For example, when the present coated member is used for automotive windshields, the resinous substrate can preferably be a transparent resinous plate-shaped member, which is made from a transparent resinous material, such as polycarbonate, polymethylmethacrylate and polystyrene.

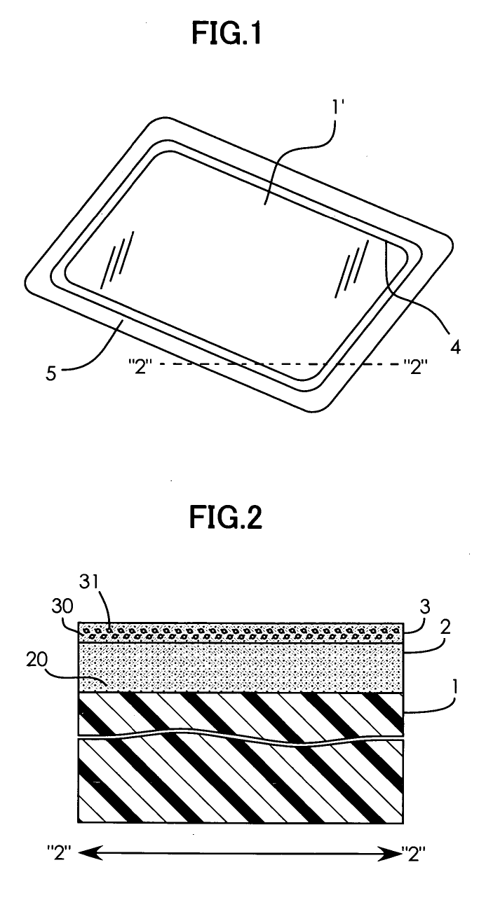

Moreover, the transparent resinous plate-shaped member can desirably be a sunroof plate-shaped member, which is composed of polycarbonate. Polycarbonate exhibits sufficient transparency and shock resistance. Accordingly, the present coated member using a polycarbonate substrate can be used suitably for an automotive windshield, especially for a sunroof, which is disposed openably and closably in an opening formed in a vehicle roof panel. Specifically, as shown in FIG. 1, a sunroof comprises a casing-shaped frame 4, and the present coated member 1′ whose periphery is held in the frame 4. Moreover, a loop-shaped weather strip 5, which is made from a flexible material such as rubber, is fitted around the peripheries of the present coated member 1′ and the frame 4. Note that the weather strip 5 secures airtightness within an automotive passenger room. In addition, as shown in FIG. 2, the present coated member 1′ has the hard coat layer 3 and the primer layer 2, which are disposed in this order from the outer side of an automobile to the inner side, at least.

Note that the present coated member is not limited to the above-described embodiment modes. For example, it is possible to mix the other substances, such as drying accelerators, light stabilizers and charging inhibitors, with the raw materials for the primer layer and hard coat layer in order to add the other functions to the present coated member, if necessary. In particular, when a water repellent agent is added to the raw material for the hard coat layer, it is possible to effectively inhibit the primer layer from peeling off the resinous substrate. Moreover, the present coated member can further have another layer, which is formed in addition to the primer layer and hard coat layer, that is, it can comprise a coat of three layers or more.

### EXAMPLES

Examples of the present coated member will be hereinafter described with reference to FIGS. 1 through 3.

### Preparation of Paint Composition P for Primer Layer

### Primer P1

152.3-g diacetone alcohol was charged into a flask, which was equipped with a stirrer, a condenser and a thermometer, as a solvent, and was heated to 80° C. while flowing a nitrogen gas. Into the heated diacetone alcohol, 240 g of a monomer mixture solution, which was prepared in advance, and 54 g of a polymerization initiator solution, which was prepared in advance, were charged in this order. Note that the monomer mixture solution was composed of 90-g γ-methacryloxypropyl trimethoxysilane, 337.5-g methylmethacrylate, 22.5-g glycidyl methacrylate, and 350-g diacetone alcohol. The polymerization initiator solution was prepared by dissolving 2.3-g 2,2′-azobis(2-methylbutyronitrile), a polymerization initiator, into 177.7-g diacetone alcohol. After reacting the monomer mixture solution with the polymerization initiator solution at 80° C. for 30 minutes, the remaining monomer mixture solution and the remaining polymerization initiator solution were dropped simultaneously to the flask, which was held at a temperature of from 80 to 90° C., over a time period of 1.5 hours. The resulting mixture solution was further stirred at a temperature of from 80 to 90° C. for 5 hours. Thus, a thermosetting-acrylic-resin paint composition was produced.

Then, the resultant thermosetting-acrylic-resin paint composition and a solution of polymethylmethacrylate resin and propylene glycol monomethyl ether were mixed in a proportion of 8:2 by solid-content mass ratio. Note that the polymethylmethacrylate was “DIANAL BR-88” produced by Mitsubishi Rayon Co., Ltd., and exhibited a weight-average molecular weight of 480,000. To the resulting mixture, 2,4-dihydroxy benzophenone as an organic ultraviolet ray-absorbing agent, and a silane coupling agent were added so that 2,4-dihydroxy benzophenone made 12 parts by mass and the silane coupling agent made 10 parts by mass when the summed solid content of the thermosetting-acrylic-resin paint composition and polymethylmethacrylate resin was taken as 100 parts by mass. Note that the silane coupling agent was “KBP-43” produced by Shin-Etsu Chemical Co., Ltd. After mixing the resultant mixture, propylene glycol monomethyl ether was added to the mixture to control the solid content to 12% by weight. Note that JIS (Japanese Industrial Standard) K6833 prescribes how to measure the solid content. Thus, a primer P1 was produced.

### Primer P2

152.3-g diacetone alcohol was charged into a flask, which was equipped with a stirrer, a condenser and a thermometer, as a solvent, and was heated to 80° C. while flowing a nitrogen gas. Into the heated diacetone alcohol, 240 g of a monomer mixture solution, which was prepared in advance, and 54 g of a polymerization initiator solution, which was prepared in advance, were charged in this order. Note that the monomer mixture solution was composed of 36-g 2-[2′-hydroxy-5′-(2-methacryloxyethyl)phenyl]-2H-benzotriazole, a (metha)acrylic acid-based derivative containing an ultraviolet ray-absorbing group, 90-g γ-methacryloxy propyltrimethoxysilane, 301.5-g methylmetacrylate, 22.5-g glycidyl methacrylate, and 350-g diacetone alcohol. 2-[2′-hydroxy-5′-(2-methacryloxyethyl) phenyl]-2H-benzotriazole was “RUVA-93” produced by Ohtsuka Chemical Co., Ltd. The polymerization initiator solution was prepared by dissolving 2.3-g 2,2′-azobis(2-methylbutyronitrile), a polymerization initiator, into 177.7-g diacetone alcohol. After reacting the monomer mixture solution with the polymerization initiator solution at 80° C. for 30 minutes, the remaining monomer mixture solution and the remaining polymerization initiator solution were dropped simultaneously to the flask, which was held at a temperature of from 80 to 90° C., over a time period of 1.5 hours. The resulting mixture solution was further stirred at a temperature of from 80 to 90° C. for 5 hours. Thus, a thermosetting-acrylic-resin paint composition, in which an ultraviolet ray-absorbing agent is fixed, was produced.

Then, the resultant thermosetting-acrylic-resin paint composition and a solution of polymethylmethacrylate resin and propylene glycol monomethyl ether were mixed in a proportion of 6:4 by solid-content mass ratio. Note that the polymethylmethacrylate was “DIANAL BR-88” produced by Mitsubishi Rayon Co., Ltd., and exhibited a weight-average molecular weight of 480,000. To the resulting mixture, a silane coupling agent was added so that the silane coupling agent made 10 parts by mass when the summed solid content of the thermosetting-acrylic-resin paint composition and polymethylmethacrylate resin was taken as 100 parts by mass. Note that the silane coupling agent was “KBP-43” produced by Shin-Etsu Chemical Co., Ltd. After mixing the resultant mixture, propylene glycol monomethyl ether was added to the mixture to control the solid content to 12% by weight. Note that JIS (Japanese Industrial Standard) K6833 prescribes how to measure the solid content. Thus, a primer P2 was produced.

### Primer P3

Except that the polymethlymethacrylate resin was changed from “DIANAL BR-88” to “DIANAL BR-80,” a primer P3 was produced in the same manner as the primer P2. Note that “DIANAL BR-80” was also produced by Mitsubishi Rayon Co., Ltd., and exhibited a weight-average molecular weight of 95,000.

### Preparation of Paint Composition H for Hard Coat Layer

### Hard Coat H1

336-g methyl triethoxysilane and 94-g isobutanol were charged into a flask, which was equipped with a stirrer, a condenser and a thermometer. The mixture was cooled with ice while being stirred, and was kept at a temperature of 5° C. or less. To the cooled mixture, 283-g water-dispersion colloidal silica, whose temperature was controlled at 5° C. or less, was added. Note that the water-dispersion colloidal silica was “SNOWTEX O” produced by Nissan Chemical Co., Ltd., and whose average particle diameter was from 15 to 20 nm, and contained 20%-by-weight SiO₂. The mixture was further stirred for 3 hours while being cooled with ice, and was furthermore stirred at a temperature of from 20 to 25° C. for 12 hours. Afterward, 27-g diacetone alcohol and 50-g propylene glycol monomethyl ether were added to the mixture. Subsequently, 3-g sodium propionate aqueous solution, whose concentration was 10% by weight, and 0.2-g polyether-modified silicone were added to the mixture. Note that the polyether-modified silicone worked as a leveling agent, and was “KP-341” produced by Shin-Etsu Chemical Co., Ltd. Moreover, the pH of the mixture was controlled with acetic acid so as to fall in a range of from 6 to 7. In addition, the solid content of the mixture was controlled with isobutanol to 20% by weight, and was aged at room temperature for 5 days. Note that JIS K6833 prescribes how to measure the solid content. Thus, a colloidal silica-containing organopolysiloxane composition was produced.

Finally, 2,4-dihydroxy benzophenone, an organic ultraviolet ray-absorbing agent, was added to the resulting colloidal silica-containing organopolysiloxane composition, and was mixed therewith. Thus, a hard coat H1 was produced. Note that the 2,4-dihydroxy benzophenone was added so as to make 3% by weight of a cured hard coat layer taken as 100% by weight.

### Hard Coat H2

170.6-g (0.6-mol) titanium tetraisopropoxide and 38.4-g (0.1-mol) zirconium tetra-n-butoxide were charged into a flask, which was equipped with a stirrer, a condenser and a thermometer. While stirring the alkoxide mixture, 70-g (0.7-mol) acetyl acetone was dropped with a dropping funnel over a time period of 30 minutes. In this instance, the temperature within the flask increased to 63° C. After aging the resulting mixture as it was stirred at room temperature for 1 hour, 44.6-g hydrochloric acid aqueous solution, whose concentration was 3% by weight, was further dropped to the mixture over a time period of 20 minutes. Note the 44.6-g hydrochloric acid aqueous solution was equivalent to 2.38-mol water. Afterward, the mixture was reacted at a temperature of from 70 to 80° C. for 10 hours, and thereby a light-tannish transparent metallic compound aqueous solution whose pH was 2.79 was produced. According to an absorbance analysis using a solution whose solid-content concentration was diluted with ethanol to 0.05 g/L, the resultant metallic compound solution absorbed light rays whose wavelength was 350 nm or less.

The thus produced metallic compound solution was added to the hard coat H1, and was mixed therewith. Thus, a hard coat H2 was produced. Note that the metallic compound solution was added in an amount of 6 parts by mass with respect to the solid content of the hard coat H1 taken as 100 parts by mass.

### Hard Coat H3

An isobutanol solution of a silicone resin, a flexibility-imparting agent, was prepared. Note that the silicone resin was “KR-220L” produced by Shin-Etsu Chemical Co., Ltd. The silicone-resin concentration of the isobutanol solution was 20% by weight. The isobutanol solution was added to the hard coat H2, and was mixed therewith. Thus, a hard coat H3 was produced. Note that the isobutanol solution was added so that its solid content was equivalent to 100 parts by mass with respect to the solid content of the hard coat H2 taken as 100 parts by mass.

### (Making of Samples “A” through “D”)

As a resinous substrate, a polycarbonate plate-shaped member, a sunroof plate-shaped member 1, was prepared. Note that the polycarbonate plate-shaped member was “ML300T” produced by Mitsubishi Engineering Plastic Co., Ltd.

Onto the sunroof plate-shaped member 1 whose surface was cleaned, one of the paint compositions P1 through P3 for primer layer was coated by a dip coating method so as to be a desired thickness. Thereafter, the one of the paint compositions P1 through P3 was dried, and was burned at 125° C. for 45 minutes to cure. Thus, a primer layer 2 was formed. Then, onto the primer layer 2, one of the paint compositions H1 through H3 for hard coat layer was coated by a flow coating method so as to be a desired thickness. Thereafter, the one of the paint compositions H1 through H3 was dried, and was burned at 130° C. for 60 minutes to cure. Thus, a hard coat layer 3 was formed. Table 1 below sets forth the types of the paint compositions P1 through P3 for primer layer and the types of the paint compositions H1 through H3 for hard coat layer, which were used in Samples “A” through “D,” and the thickness of the resulting primer layers 2 and hard coat layers 3. Moreover, Table 2 below summarizes the major compositions of the primer layers 2 and hard coat layers 3 in Samples “A” through “D”.

TABLE 1

| Sample | Sample “A” | Sample “B” | Sample “C” | Sample “D” |
|---|---|---|---|---|
| Hard Coat | H1 | H2 | H3 | H3 |
| Layer | 4 μm | 4 μm | 4 μm | 4 μm |
| Primer Layer | P1 | P2 | P2 | P3 |
| | 6 μm | 6 μm | 12 μm | 12 μm |
| XENON | 800 hr. | 2,000 hr. | 4,000 hr. | 4,500 hr. |
| (specified | Cracked & | Cracked | Peeled-off | Peeled-off |
| hours or | Peeled-off | | | |
| more)/State | | | | |

TABLE 2

| Used Paint Composition | P1 | P2 | P3 | H1 | H2 | H3 |
|---|---|---|---|---|---|---|
| Flexibility-imparting Agent | N.A. | N.A. | N.A. | 0 | 0 | 50 |
| (% by Weight) *1 | | | | | | |
| Ratio of Thermosetting Resin | 8:2 | 6:4 | 6:4 | N.A. | N.A. | N.A. |
| to Thermoplastic Resin *2 | | | | | | |
| Weight-average Molecular | 48 | 48 | 9.5 | N.A. | N.A. | N.A. |
| Weight of Thermoplastic | | | | | | |
| Resin (×10⁴) | | | | | | |

*1 specifies a proportion of the flexibility-imparting agent with respect to the cured hard coat layer taken as 100% by weight.
*2 specifies a weight ratio of the acrylic resin components.
“N.A.” stands for “not applicable”.

Note that FIG. 2 is a cross-sectional diagram for schematically illustrating Sample “C” or Sample “D,” and is equivalent to the cross section, which is taken along the dotted line “2”-“2” of FIG. 1, when Sample “C” or Sample “D” was assembled with a frame 4 and a weather strip 5 to complete a sunroof. A coated member 1′ of Sample “C” or Sample “D” comprised a sunroof plate-shaped member 1, a primer layer 2, and a hard coat layer 3. The primer layer 2 was formed on the surface of the sunroof plate-shaped member 1, and contained a fixed ultraviolet ray-absorbing agent 20. The hard coat layer 3 was formed on the primer layer 2, and contained an ultraviolet ray-absorbing agent 30 and a silicone resin 31.

### Evaluation

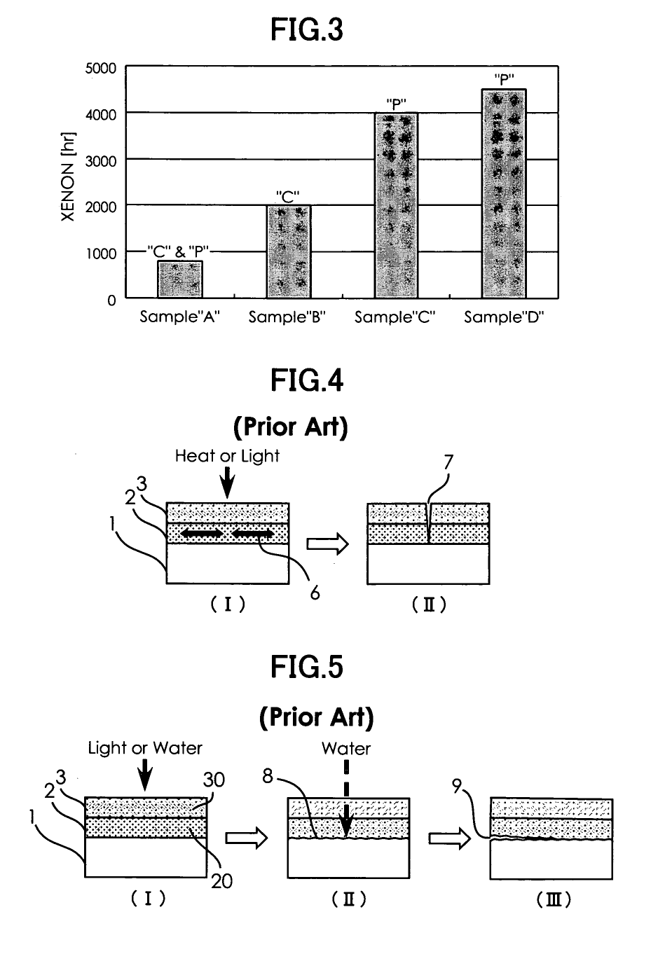

Samples “A” through “D” were examined for the weatherability. In the weatherability examination, Samples “A” through “D” were subjected to a xenon lamp-type facilitated weatherability test in accordance with JIS K1415, using a xenon weatherometer (hereinafter abbreviated to as “XENON”), and were thereby measured for times until cracking or peeling-off was noticed visually in their coats (hereinafter referred to as “SUV-cycle numbers”). FIG. 3 illustrates the results of the weatherability examination. Note that, in FIG. 3., “C” or “P” designates that cracking or peeling-off was noticed visually in Samples “A” through “D.”

According to the results of the weatherability examination, Sample “C” and Sample “D,” which comprised the hard coat layer 30 composed of the silicone resin 31, a flexibility-imparting agent, exhibited SUV-cycle numbers twice or more as long as an SUV-cycle number exhibited by Sample “A.” Thus, Sample “C” and Sample “D” were found to be coated members whose weatherability adhesiveness and weatherability crack resistance were better than those of conventional coated members. Moreover, Sample “C” and Sample “D” comprised the primer layer 2, which had the thickened thickness, 12 μm. Accordingly, the primer layer 2 included the fixed ultraviolet ray-absorbing agent 20 in an increased amount. Consequently, Sample “C” and Sample “D” made coated members whose weatherability adhesiveness and weatherability crack resistance were much better than those of Sample “B.”

In addition, Sample “C” and Sample “D” demonstrated remarkably good weatherability performance, that is, they exhibited an SUV-cycle number of 3,000 hours or more, respectively, in the weatherability examination using XENON. Since Sample “C” and Sample “D” thus showed sharply upgraded weatherability adhesiveness and weatherability crack resistance, it is understood that they are suitable for automotive sunroofs, for example.

Having now fully described the present invention, it will be apparent to one of ordinary skill in the art that many changes and modifications can be made thereto without departing from the spirit or scope of the present invention as set forth herein including the appended claims.

What is claimed is:

1. A coated member, comprising:
a resinous substrate;
a primer layer formed on a surface of the resinous substrate, and composed of a resinous primer; and
a hard coat layer formed on the primer layer, and containing a flexibility-imparting agent;
at least one of the primer layer and the hard coat layer further containing an ultraviolet ray-absorbing agent.

2. The coated member set forth in claim 1, wherein the hard coat layer contains the flexibility-imparting agent in an amount of from 3 to 60% by weight when the hard coat layer is taken as 100% by weight.

3. The coated member set forth in claim 1, wherein the primer layer contains an ultraviolet ray-absorbing agent, and has a thickness of 8 μm or more.

4. The coated member set forth in claim 1, wherein the resinous primer comprises an acrylic primer.

5. The coated member set forth in claim 4, wherein the acrylic primer comprises a thermosetting acrylic resin and a thermoplastic acrylic resin in a proportion of the thermosetting acrylic resin with respect to the thermoplastic acrylic resin falling in a range of from 95:5 to 30:70 by weight ratio.

6. The coated member set forth in claim 5, wherein the acrylic primer comprises the thermoplastic acrylic resin whose weight-average molecular weight falls in a range of from 5,000 to 800,000.

7. The coated member set forth in claim 1, wherein the primer layer contains an ultraviolet ray-absorbing agent, and the ultraviolet ray-absorbing agent comprises a fixed ultraviolet ray-absorbing agent, which is fixed to the resinous primer by means of chemical bond.

8. The coated member set forth in claim 1, wherein the hard coat layer is a film, which comprises silicon oxide.

9. The coated member set forth in claim 1, wherein the hard coat layer contains an ultraviolet ray-absorbing agent, and the ultraviolet ray-absorbing agent comprises an inorganic ultraviolet ray-absorbing agent.

10. The coated member set forth in claim 1, wherein the hard coat layer has a thickness of from 3 to 5 μm.

11. The coated member set forth in claim 1, wherein the resinous substrate is a transparent resinous plate-shaped member which exhibits transparency.

12. The coated member set forth in claim 11, wherein the transparent resinous plate-shaped member is a sunroof plate-shaped member which is composed of polycarbonate.
